(19) United States
(12) Patent Application Publication
(10) Pub. No.: US 2023/0069409 A1
(43) Pub. Date: Mar. 2, 2023

(54) POLYMER GEL ELECTROLYTE AND LITHIUM METAL BATTERY INCLUDING SAME

(71) Applicants: Hyundai Motor Company, Seoul (KR); Kia Corporation, Seoul (KR); Industry-University Cooperation Foundation Hanyang University, Seoul (KR)

(72) Inventors: Eun Ji Kwon, Uiwang, Gyeonggi-do (KR); Samuel Seo, Uiwang, Gyeonggi-do (KR); Won Kuen Kim, Uiwang, Gyeonggi-do (KR); Kyoung Han Ryu, Uiwang, Gyeonggi-do (KR); Kyu Ju Kwak, Uiwang, Gyeonggi-do (KR); Yeon Jong Oh, Uiwang, Gyeonggi-do (KR); Dong Won Kim, Seoul (KR); Ji Wan Kim, Seoul (KR); Bo Hyung Lee, Seoul (KR); Myung Keun Oh, Seoul (KR); Hyun Sik Woo, Seoul (KR)

(21) Appl. No.: 17/898,700

(22) Filed: Aug. 30, 2022

(30) Foreign Application Priority Data
Aug. 31, 2021 (KR) 10-2021-0115190

(51) Int. Cl. H01M 10/0565; H01M 50/46; H01M 50/483

(52) U.S. Cl. CPC H01M 10/0565; H01M 50/46; H01M 50/483; H01M 2220/20; H01M 2300/0082

(57) ABSTRACT

Disclosed are a polymer gel electrolyte composition, a polymer gel electrolyte prepared from the composition, and a lithium secondary battery including the electrolyte are proposed. The polymer gel electrolyte may be formed by thermal cross-linking of the polymer gel electrolyte composition including an ether-based organic solvent with excellent compatibility with a lithium metal anode, a nitrate capable of forming a stable film on an electrode surface, and an appropriate ratio of a cross-linking agent having two or more acrylate functional groups. Therefore, the polymer gel electrolyte can smoothly penetrate the anode to form an ion transport channel and improve oxidation stability through interaction between the polymer and the solvent thereof, thereby improving battery life.

### CROSS REFERENCE TO RELATED APPLICATION

The present application claims priority to Korean Patent Application No. 10-2021-0115190, filed Aug. 31, 2021, the entire contents of which is incorporated herein for all purposes by this reference.

### TECHNICAL FIELD

The present disclosure relates to a polymer gel electrolyte composition, a polymer gel electrolyte prepared therefrom, and a lithium metal battery including the same.

### BACKGROUND

A lithium metal battery is a lithium secondary battery using lithium metal as an anode material. Lithium metal is an ideal material for anodes for high energy density secondary batteries because its specific capacity is 10 times greater than that of graphite used as anodes for conventional lithium-ion batteries.

However, for lithium metal batteries to be commercialized, there is still room for improvement in many points. For example, when lithium metal is used as an anode material, the liquid electrolyte is decomposed due to the high reactivity of the lithium metal, thereby forming a high-resistance film, resulting in reduction in battery capacity and lifespan. In addition, a lithium anode suffers dendritic lithium dendrites growing due to the concentration of non-uniform current density in the oxidation/reduction process, and the lithium dendrites contribute to the formation of “dead Li”, thereby causing the loss of the lithium anode. This reduces battery lifespan and causes a safety problem attributable to a short circuit between the anode and the cathode.

To solve this problem, various electrolytes have been proposed to form a stable SEI on lithium metal to suppress dendrite formation and side reactions of an electrolyte in a lithium metal anode. However, due to the low oxidation stability of a solvent, when such electrolytes were applied to a high voltage layered cathode, there was a problem of showing poor lifespan characteristics.

### SUMMARY

In one preferred aspect, provided is a polymer gel electrolyte composition including a lithium salt, an ether-based organic solvent having excellent compatibility with a lithium metal anode, a nitrate capable of forming a stable film on the surfaced of an electrode, and a cross-linking agent having two or more acrylate functional groups. The polymer gel electrolyte may be formed by thermal cross-linking of the composition.

A term “ether-based organic solvent” or “ether-based solvent” as used herein refers to a solvent component having a structure including one or more ether group (e.g., R—O—R′, wherein each R and R′ is independently hydrocarbon, e.g., alkyl, cycloalkyl, or aryl), which constitutes more than about 50%, about 55%, about 60%, about 65%, about 70%, about 75%, 80%, about 85%, about 90%, about 95%, or about 99% of the total volume of the solvent.

In one preferred aspect, provided is a lithium metal battery including an anode, a cathode, and a separator interposed between the anode and the cathode and including a polymer gel electrolyte. The battery further includes a protective layer including nanofibers between the anode and the separator, which includes an oxide having a double bond.

In one aspect, provided is a polymer gel electrolyte composition including a lithium salt, an ether-based organic solvent, and a nitrate.

The polymer gel electrolyte composition may further include a cross-linking agent having two or more acrylate functional groups.

The polymer gel electrolyte composition may suitably include the cross-linking agent in an amount of about greater than 2% by weight but not greater than 4% by weight (e.g., equal to or less than about 4% by weight) respect to 100% by weight of the polymer gel electrolyte composition.

The cross-linking agent may suitably include one or more substances selected from the group consisting of trimethylolpropane triacrylate, di-trimethylolpropane tetraacrylate, ethoxylated trimethylolpropane triacrylate, butane diol diacrylate, tripropylene glycol diacrylate, and trimethylolpropane trimethacrylate.

The lithium salt may suitably include one or more salts selected from the group consisting of LiN(SO₂F)₂, LiN(SO₂C₂F₅)₂, LiN(CF₃SO₂)₂, LiPF₆, LiBF₄, LiClO₄, LiCF₃SO₃, LiC₄F₉O₃, LiC₆H₅SO₃, LiSCN, LiB(C₂O₄)₂, LiPO₂F₂, and LiDFOP.

The ether-based solvent may suitably include one or more substances selected from the group consisting of 1,2-dimethoxyethane, 1,3-dioxolane, and tetrahydrofuran.

The nitrate may suitably include one or more selected from the group consisting of LiNO₃, NaNO₃, KNO₃, Mg(NO₃)₂, Ca(NO₃)₂, and Ag(NO₃)₂.

In another aspect, provided is a polymer gel electrolyte formed by thermal cross-linking of the polymer gel electrolyte composition.

The thermal cross-linking may be performed by heat treatment at a temperature in a range of about 60° C. to 90° C. for about 1 hour to 5 hours.

In a further aspect, provided is a lithium metal battery including a cathode, an anode, and a separator interposed between the cathode and the anode, and the polymer gel electrolyte as described herein disposed in the separator.

The lithium metal battery may further include a protective layer disposed between the anode and the separator.

The protective layer may include nanofibers including an oxide having a double bond.

The nanofiber may suitably include an ion conductive polymer including one or more substance selected from the group consisting of polyethylene oxide, polypropylene oxide, polyurethane, polyethylene carbonate, polypropylene carbonate, polyethylene adipate, and polybutylene adipate.

The double bond on the surface of the oxide may suitably include one or more selected from the group consisting of a vinyl group and an acrylate group.

The oxide may suitably include one or more selected from the group consisting of alumina, magnesium oxide, and an oxide-based solid electrolyte.

The oxide may have a diameter of about 20 nm to 400 nm.

The size of diameter of a substance particle (e.g., oxide) may be measured by maximum direct distance between two points the surface of the particle.

Since the polymer gel electrolyte according to various exemplary embodiments of the present disclosure embodiment is formed by thermal cross-linking of the polymer gel electrolyte composition including an ether-based organic solvent with excellent compatibility with a lithium metal anode, a nitrate capable of forming a stable film on an electrode surface, and an appropriate ratio of a cross-linking agent having two or more acrylate functional groups, the polymer gel electrolyte can smoothly penetrate into the anode to form an ion transport channel. In addition, the polymer gel electrolyte can improve oxidation stability through interaction between the polymer and the solvent thereof, thereby improving battery life.

Since the lithium metal battery according to various exemplary embodiment includes a separator including the polymer gel electrolyte and also includes a protective layer disposed between the anode and the separator and including nanofibers including an oxide having a double bond, a stable interface area may be formed between the lithium metal anode and the electrolyte due to the presence of the polymer gel electrolyte and the protective layer, and a three-dimensional network structure that is effective in suppressing lithium dendrites can be formed because the embedded oxide participates in a chemical reaction.

In further aspects, vehicles are provided that comprise a lithium metal battery as disclosed herein.

### BRIEF DESCRIPTION OF THE DRAWINGS

FIGS. 1A and 1B show results of a 4.2 V constant voltage test of coin cells respectively including a polymer gel electrolyte composition according to Example 1 (FIG. 1A) and Comparative Example 1 (FIG. 1B);

FIGS. 2A and 2B show SEM images of the surface of an aluminum current collector of each of coin cells respectively including a polymer gel electrolyte composition according to Example 1 (FIG. 2A) and Comparative Example 1 (FIG. 2B) after a 4.2 V constant voltage test of the coin cells;

FIGS. 3A to 3C show polymerization results of polymer gel electrolytes prepared according to Comparative Example 2 (FIG. 3A), Comparative Example 3 (FIG. 3B), and Example 2 (FIG. 3C);

FIG. 4 shows a ¹H NMR measurement graph of the polymer gel electrolyte according to Example 2;

FIG. 5 shows a graph showing ionic conductivity analysis results of the polymer gel electrolyte compositions according to Example 1 and Comparative Example 1 and the polymer gel electrolyte according to Example 2;

FIGS. 6A and 6B show graphs showing leakage current test results at 4.20 V, 4.25 V, and 4.30 V of the polymer gel electrolyte composition according to Comparative Example 1 (FIG. 6A) and the polymer gel electrolyte according to Example 2 (FIG. 6B);

FIG. 7 shows a graph showing linear scanning potential test results of the polymer gel electrolyte composition according to Example 1 and the polymer gel electrolyte according to Example 2; and

FIG. 8 shows a graph showing charge and discharge results of cells according to Comparative Example 3, Example 3, and Example 4.

### DETAILED DESCRIPTION

Above objectives, other objectives, features, and advantages will be readily understood from the following preferred embodiments associated with the accompanying drawings. However, the embodiments described herein may be embodied in other forms. The embodiments described herein are provided so that the invention can be made thorough and complete and that the spirit of the present disclosure can be fully conveyed to those skilled in the art.

Throughout the drawings, like elements are denoted by like reference numerals. In the accompanying drawings, the dimensions of the structures are larger than actual sizes for clarity of the present disclosure. Terms used in the specification, “first”, “second”, etc., may be used to describe various components, but the components are not to be construed as being limited to the terms. These terms are used only for the purpose of distinguishing a component from another component. For example, a first component may be referred as a second component, and the second component may be also referred to as the first component. As used herein, the singular forms “a”, “an”, and “the” are intended to include the plural forms as well unless the context clearly indicates otherwise.

It will be further understood that the terms “comprises”, “includes”, or “has” when used in this specification specify the presence of stated features, regions, integers, steps, operations, elements and/or components, but do not preclude the presence or addition of one or more other features, regions, integers, steps, operations, elements, components and/or combinations thereof. It will also be understood that when an element such as a layer, film, area, or sheet is referred to as being “on” another element, it can be directly on the other element, or intervening elements may be present therebetween. Similarly, when an element such as a layer, film, area, or sheet is referred to as being “under” another element, it can be directly under the other element, or intervening elements may be present therebetween.

Unless otherwise specified, all numbers, values, and/or representations that express the amounts of components, reaction conditions, polymer compositions, and mixtures used herein are to be taken as approximations including various uncertainties affecting measurement that inherently occur in obtaining these values, among others, and thus should be understood to be modified by the term “about” in all cases. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Furthermore, when a numerical range is disclosed in this specification, the range is continuous, and includes all values from the minimum value of said range to the maximum value thereof, unless otherwise indicated. Moreover, when such a range pertains to integer values, all integers including the minimum value to the maximum value are included, unless otherwise indicated.

In this specification, where a range of a variable is described, it will be understood that the variable includes all values within the stated range, including the stated endpoints of the range. For example, a range of 5 to 10 includes: integer values such as 5, 6, 7, 8, 9, and 10; any subranges such as 6 to 10, 7 to 10, 6 to 9, 7 to 9, and the like; and any values between integers such as 5.5, 6.5, 7.5, 5.5 to 8.5 and 6.5 to 9, and the like. For example, a range of 10% to 30% includes: any integer percentages such as 10%, 11%, 12%, 13%, and the like, inclusive of 30%; any sub ranges such as 10% to 15%, 12% to 18%, 20% to 30%, and the like; and any non-integer percentages between integer percentages such as 10.5%, 15.5%, 25.5%, and the like.

Disclosed herein, inter alia, is a polymer gel electrolyte formed by thermal cross-linking of a polymer gel electrolyte composition including an ether-based organic solvent with excellent compatibility with a lithium metal anode, nitrate capable of forming a stable film on an electrode surface, and an appropriate ratio of a cross-linking agent having two or more acrylate functional groups have advantages described below. The polymer gel electrolyte can smoothly penetrate an anode to form an ion transport channel and improve oxidation stability through interaction between the polymer and the solvent thereof, thereby improving battery life. Thus, the inventors have completed preparation of a polymer gel electrolyte.

In addition, t disclose herein is a lithium metal battery including a separator including the polymer gel electrolyte and a protective layer disposed between a anode and a separator and including nanofibers including an oxide having a double bond, the polymer gel electrolyte and the protective layer may generate a stable interface between the lithium anode and the electrolyte, and the embedded oxide participates in a chemical reaction to form a three-dimensional network structure that is effective in suppressing lithium dendrites.

In one aspect, the polymer gel electrolyte composition that may be thermally cross-linked to prepare the polymer gel electrolyte includes a lithium salt, an ether-based organic solvent excellent in compatibility with a lithium metal anode, and a nitrate capable of forming a stable film on an electrode surface and preferably may further include a cross-linking agent having two or more acrylate functional groups.

The lithium salt may be dissolved in an ether-based organic solvent to serve as a charge carrier, and any lithium salt that has been commonly used in electrolytes for lithium metal batteries may be used without limitation. The lithium salt may suitably include one or more salts selected from the group consisting of LiN(SO₂F)₂, LiN(SO₂C₂F₅)₂, LiN(CF₃SO₂)₂, LiPF₆, LiBF₄, LiClO₄, LiCF₃SO₃, LiC₄F₉O₃, LiC₆H₅SO₃, LiSCN, LiB(C₂O₄)₂, LiPO₂F₂, and LiDFOP.

The ether-based organic solvent may have excellent compatibility with lithium metal used as an anode electrode material and may be preferably used together with a fluorine-based organic solvent to further improve oxidation stability.

A term “fluorine-based organic solvent” or “ether-based solvent” as used herein refers to a solvent component having a structure including one or more ether groups (e.g., R—O—R′, wherein each R and R′ is independently hydrocarbon, e.g., alkyl, cycloalkyl, or aryl) and one or more fluorines, which constitutes more than about 50%, about 55%, about 60%, about 65%, about 70%, about 75%, 80%, about 85%, about 90%, about 95%, or about 99% of the total volume of the solvent.

When the ether-based organic solvent and the fluorine-based organic solvent are used together, the volume ratio of the ether-based organic solvent to the fluorine-based organic solvent may be about 3 to 5:1 and may be preferably 3.5 to 4.5:1. When the volume ratio is out of the range, when the volume of the ether-based organic solvent is less than that of the suitably, the solubility of the lithium salt and the ionic conductivity of the electrolyte may be reduced, and the film formation resistance increases due to the excess fluorine-based solvent. On the other hand, when the volume of the ether-based organic solvent is excessively large, since the viscosity of the electrolyte increases, the wettability of components in the battery may be greatly reduced, there is a disadvantage in that processability is reduced.

The ether-based solvent may include one or more substances selected from the group consisting of 1,2-dimethoxyethane, 1,3-dioxolane, and tetrahydrofuran.

In addition, when the fluorine-based organic solvent is additionally used, the fluorine-based organic solvent may suitably include one or more substances selected from the group consisting of 1,1,2,2-tetrafluoroethyl-1H,1H,5H-octafluoropentyl ether (TFOFE), 1,1,2,2-tetrafluoroethyl-2,2,2,3-tetrafluoropropyl ether (TIE), bis(2,2,2-trifluoroethyl) ether (BTFE), 1,1,2,2-tetrafluoroethyl-2,2,2-trifluoroethyl ether (TFTFE), methoxynona fluorobutane (MOFB), and ethoxynonafluorobutane (EOFB).

The nitrate may form a stable film on the surface of an electrode during charging and discharging, so it may inhibit the corrosion reaction of a metal that can be used as a cathode. The nitrate may suitably include one or more selected from the group consisting of LiNO₃, NaNO₃, KNO₃, Mg(NO₃)₂, Ca(NO₃)₂, and Ag(NO₃)₂.

In addition, an imide salt may be further included. The imide salt may suitably include one or more selected from the group consisting of lithium bis(fluorosulfonyl)imide (LiFSI), lithium bis(trifluoromethanesulfonyl)imide, and lithium bis(pentafluoroethanesulfonyl)imide (LiBETI).

In addition, the polymer gel electrolyte composition may further include a cross-linking agent having two or more acrylate functional groups, so that the polymer gel electrolyte can be prepared by thermal cross-linking subsequently performed. Due to the cross-linking agent contained in an appropriate amount, oxidation stability can be improved.

The polymer gel electrolyte composition may include the cross-linking agent preferably in an amount in a range of greater than about 2% by weight and not greater than about 4% by weight based on 100% by weight of the total polymer gel electrolyte composition. The polymer gel electrolyte composition may include the cross-linking agent in an amount in a range of greater than 2% by weight and not greater than 4% by weight based on 100% by weight of the total polymer gel electrolyte composition. When the content of the cross-linking agent is out of the range, specifically when the content of the cross-linking agent is less than about 2% by weight or equal to 2% by weight, the physical properties of the polymer gel electrolyte may be weakened even through the polymerization reaction proceeds. On the other hand, when the content of the cross-linking agent is greater than 4% by weight, the cross-linking density increases, thereby reducing the ionic conductivity of the electrolyte and increasing the cell resistance.

In addition, the cross-linking agent may have two or more acrylate functional groups, and preferably may have 2 to 6 acrylate functional groups. Specifically, the C═O group of the acrylate functional group improves the oxidation stability of the electrolyte through interaction with lithium ions and with the ether-based solvent, thereby improving lifespan characteristics when a high voltage layered cathode is used. The cross-linking agent may suitably include one or more substances selected from the group consisting of trimethylolpropane triacrylate, di-trimethylolpropane tetraacrylate, ethoxylated trimethylolpropane triacrylate, butane diol diacrylate, tripropylene glycol diacrylate, and trimethylolpropane trimethacrylate.

The polymer gel electrolyte composition including a lithium salt having the characteristics described above, an ether-based organic solvent, a nitrate, and a crosslinking agent may be thermally cross-linked to form a polymer gel electrolyte.

The thermal cross-linking may be performed by heat treatment at a temperature in the range of about 60° C. to about 90° C. for about 1 to 5 hours.

When the heat treatment is performed in a condition outside the range, particularly, when the heat treatment temperature is less than about 60° C., the radical initiation of the initiator may not start so that the thermal polymerization reaction does not proceed. Conversely, when the heat treatment temperature is greater than about 90° C., side reactions occur in the electrolyte and the electrode. On the other hand, when the heat treatment time is less than about 1 hour, the polymerization reaction cannot be completed so that unreacted residues may remain. When the heat treatment time is greater than about 5 hours, the electrolyte may volatilize and changes in physical properties.

That is, since the polymer gel electrolyte is formed by thermal cross-linking of the polymer gel electrolyte composition including an ether-based organic solvent with excellent compatibility with a lithium metal anode, nitrate capable of forming a stable film on an electrode surface, and an appropriate ratio of a cross-linking agent having two or more acrylate functional groups, the polymer gel electrolyte may smoothly penetrate into the anode to form an ion transport channel and improve oxidation stability through interaction between the polymer and the solvent thereof, thereby improving battery life.

Also disclosed herein is the lithium metal battery includes a cathode, an anode, and a separator interposed between the cathode and the anode. The polymer gel electrolyte may be included or disposed in the separator, and preferably, a protective layer may be disposed between the anode and the separator.

The protective layer may include nanofibers including an oxide having a double bond on the surface thereof is embedded. The protective layer may suitably include nanofibers embedding an oxide having a double bond on the surface thereof. By having the oxide embedded in the nanofiber, the oxide participates in the cross-linking reaction, thereby improving mechanical properties and improving the adhesion between the protective layer and the gel polymer electrolyte.

The protective layer may be prepared through electrospinning, and an electrospinning solution for electrospinning is prepared by mixing an ion conductive polymer that can be used to prepare nanofibers and an oxide having a double bond on the surface in a solvent, followed by electrospinning.

The nanofiber may contain an ion conductive polymer including one or more substances selected from the group consisting of polyethylene oxide, polypropylene oxide, polyurethane, polyethylene carbonate, polypropylene carbonate, polyethylene adipate, and polybutylene adipate.

In addition, the oxide may suitably include one or more selected from the group consisting of alumina, silica, titanium oxide, and oxide-based solid electrolytes. The oxide may have a diameter of about 20 nm to 400 nm. When the diameter is less than about 20 nm, the specific surface area is large thereby resulting in high viscosity and poor dispersibility. On the other hand, when the diameter is greater than about 400 nm, it is difficult to internalize the oxide when manufacturing the nanofiber membrane, and non-uniformity may occur in the interface between the separator and the electrode, resulting in current density imbalance between components in the cell.

The double bond on the surface of the oxide (i.e., ═O) may be from one or more functional groups selected from the group consisting of a vinyl group, an acrylate group, and a methacrylate group. As such, due to the presence of the double bond on the surface of the oxide embedded in the nanofiber, there is an advantage that the oxide can directly participate in the cross-linking reaction.

The content of the oxide included in the protective layer may be in a range of about 1% to 10% by weight with respect to 100% by weight of the entire protective layer. When the content of the oxide is less than about 1% by weight, there is a disadvantage that the mechanical properties are too weak to suppress the occurrence or growth of lithium dendrites. On the other hand, the content of the oxide is greater than about 10% by weight, it is difficult to obtain the effect of uniform dispersion, thereby being able to form nanofibers.

The protective layer satisfying the characteristics described above not only forms a stable interface between the lithium anode and the polymer gel electrolyte during charging and discharging but also forms a three-dimensional network structure due to participation of the oxide in a chemical reaction, thereby effectively inhibiting lithium dendrites.

On the other hand, the cathode may include a cathode active material, a binder, a conductive agent, and the like.

The cathode active material may suitably include one or more selected from the group consisting of lithium cobalt oxide, lithium nickel cobalt manganese oxide, lithium nickel cobalt aluminum oxide, lithium iron phosphate, and lithium manganese oxide. However, the cathode active material is not limited thereto, and any cathode active material available in the art can be used. Preferably, the cathode active material may include at least one selected from the group consisting of LiCoO₂, Li(NiₓCo_{y}Mn_{z})O₂ [x+y+z=1], Li(NiₓCo_{y}Al_{z})O₂ [x+y+z=1], and LiFePO₄.

The binder is a component that assists in bonding the cathode electrode active material and the conductive agent and bonding to the current collector, and the binder may suitably include polyvinylidene fluoride, polyvinyl alcohol, carboxymethyl cellulose (CMC), starch, hydroxypropyl cellulose, regenerated cellulose, polyvinylpyrrolidone, tetrafluoroethylene, polyethylene, polypropylene, ethylene-propylene-diene terpolymer (EPDM), sulfonated EPDM, styrene butadiene rubber, fluororubber, various copolymers, or combinations thereof.

The conductive agent is not particularly limited if it has conductivity without causing a chemical change in the battery. For example, the examples of the conductive agent may suitably include: graphite such as natural graphite or artificial graphite; carbon-based substances such as carbon black, acetylene black, ketjen black, channel black, furnace black, lamp black, and summer black; conductive fibers such as carbon fibers and metal fibers; powder of metal such as carbon fluoride, aluminum, and nickel; conductive whiskeys such as zinc oxide and potassium titanate; conductive metal oxides such as titanium oxide; and conductive materials such as polyphenylene derivatives.

A lithium metal may be used for the anode, and the thickness of the lithium metal is not particularly limited if it can be used in a lithium metal battery.

According to various exemplary embodiments, since the lithium metal battery includes a separator including the polymer gel electrolyte and also includes a protective layer disposed between the anode and the separator and including nanofibers in which an oxide having a double bond on the surface thereof is embedded, a stable interface area may be formed between the lithium metal anode and the electrolyte due to the presence of the polymer gel electrolyte and the protective layer, and a three-dimensional network structure that is effective in suppressing lithium dendrites may be formed because the embedded oxide participates in a chemical reaction.

### EXAMPLE

The present disclosure will be described in more detail with reference to examples described below. The examples described below are presented only to help understanding of the present disclosure, and the scope of the present disclosure is not limited thereto.

### Example 1: Preparation of Polymer Gel Electrolyte Composition

1,3-dimethoxyethane (DME) as an ether-based organic solvent and fluorinated ether 1,1,2,2-tetrafluoroethyl-1H,1H,5H-octafluoropentyl ether (TFOFE) as a fluorine-based organic solvent were mixed in a volume ratio of 80:20. 2.5 M of lithium bis(fluorosulfonyl)imide (LiFSI) as an imide salt, 0.3% by weight of lithium difluorophosphate as a lithium salt, and 1% by weight of lithium nitrate as a nitrate were added to the solvent mixture to obtain a polymer gel electrolyte composition.

### Example 2: Preparation of Polymer Gel Electrolyte

To the polymer gel electrolyte composition prepared according to Example 1, trimethylolpropane triacrylate (TMPTMA) as a cross-linking agent was added in an amount of 4% by weight, and 2,2-azobisisobutyronitrile (AIBN) as a polymerization initiator was added in an amount of 1% by weight relative to the amount of the cross-linking agent. Then, these are well mixed, and a cross-linking reaction was performed at a temperature of 70° C. for 3 hours to obtain a polymer gel electrolyte.

### Example 3: Manufacture of Cell Including Polymer Gel Electrolyte

As an anode, an electrode having a structure in which a lithium metal is laminated to a thickness of 45 μm on a copper current collector was prepared. In addition, a cathode in which LiNi_{0.6}Co_{0.2}M_{0.2}O₂ as a cathode active material was loaded in an amount of 2.95 mAh/cm² was prepared.

In addition, a polyethylene separator was prepared as a separator. Next, the polymer gel electrolyte according to Example 2 was charged into the separator to obtain a cell as a final product.

### Example 4: Manufacture of Cell Including Polymer Gel Electrolyte

In comparison with Example 3, a protective layer was additionally coated on the separator. An electrospinning solution was prepared by dissolving 4% to 7% by weight of polyethylene oxide and 3% by weight of reactive alumina relative to the amount of polymer in an acetonitrile solvent and stirring the mixture at a temperature of 60° C. for 24 hours. After injecting the prepared solution into a syringe and a spinning nozzle, a voltage of 14 kV was applied so that the solution can be electrospun on the separator. Next, drying was performed in a vacuum oven at a temperature of 60° C. for 24 hours or longer to remove the residual solvent and moisture. Thus, a protective layer was obtained.

Next, a cell was prepared in the same manner as in Example 3, except that the protective layer coated on the separator was disposed to face the anode.

### Comparative Example 1: Preparation of Polymer Gel Electrolyte Composition

In comparison with Example 1, a polymer gel electrolyte composition was prepared in the same manner as in Example 1 except that lithium nitrate, which is a nitrate, was not added.

### Comparative Examples 2 and 3: Preparation of Polymer Gel Electrolyte

In comparison with Example 2, polymer gel electrolytes were prepared in the same manner as in Example 2, except that the content of the cross-linking agent was changed to 1% by weight (Comparative Example 2) and 2% by weight (Comparative Example 3).

### Comparative Example 3: Manufacture of Cell Including Polymer Gel Electrolyte Composition

In comparison with Example 3, a cell was prepared in the same manner as in Example 3, except that the polymer gel electrolyte composition according to Comparative Example 1 was used instead of the polymer gel electrolyte according to Example 2, and the protective layer was not included.

### Experimental Example 1: Inspection for Corrosion by Polymer Gel Electrolyte Composition Depending on Presence and Absence of Nitrate

To evaluate corrosion of an aluminum current collector (a cathode current collector), coin cells for constant current test were manufactured with the polymer gel electrolyte composition according to Example 1 and the polymer gel electrolyte composition according to Comparative Example 1, respectively. The coin cells were structured to include an aluminum metal cathode having a diameter of 14 mm was, a lithium metal anode having a diameter of 16 mm diameter lithium metal, and a polyethylene separator to isolate the cathode and the anode from each other, in which the polymer gel electrolyte composition according to Example 1 or the polymer gel electrolyte composition according to Comparative Example 1 was included in the separator.

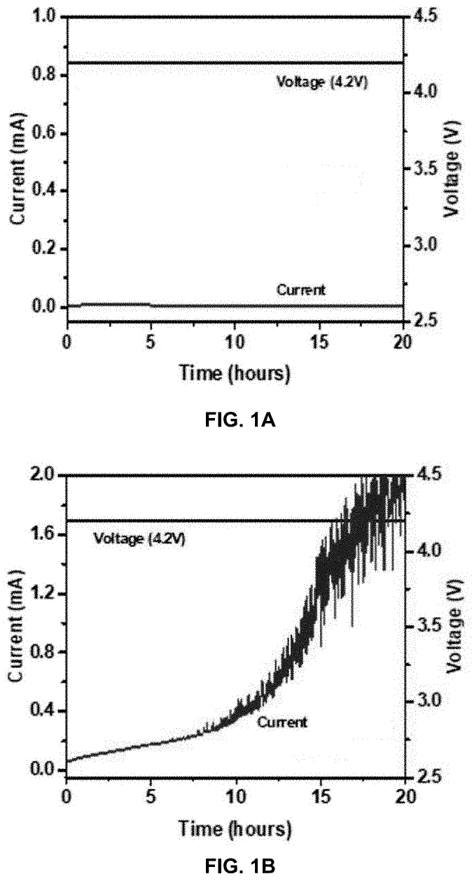

FIGS. 1A and 1B show the results of a 4.2 V constant voltage test of the coin cells respectively including the polymer gel electrolyte composition according to Example 1 (FIG. 1A) and the polymer gel electrolyte composition Comparative Example 1 (FIG. 1B), respectively.

As shown in FIGS. 1A and 1B, in the case of the coin cell manufactured with the polymer gel electrolyte composition according to Comparative Example 1, an abnormal current was detected due to aluminum corrosion. On the other hand, in the case of the coin cell manufactured with the polymer gel electrolyte composition according to Example 1, abnormal current did not occur.

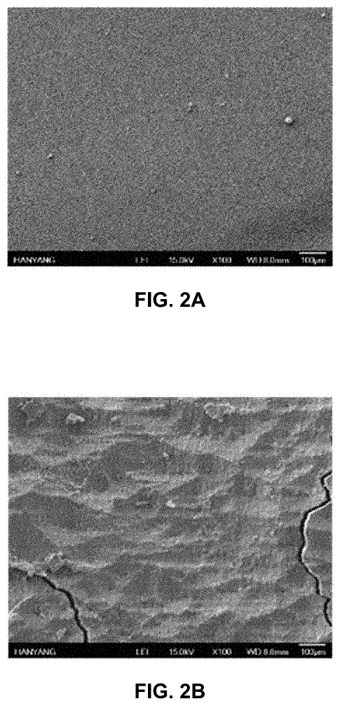

In addition, FIGS. 2A and 2B show SEM images of the surface of an aluminum current collector of each of the coin cells respectively including the polymer gel electrolyte composition according to Example 1 (FIG. 2A) and the polymer gel electrolyte composition according to Comparative Example 1 (FIG. 2B) after the 4.2 V constant voltage test of the coin cells was performed.

As shown in FIGS. 2A and 2B, in the case of the coin cell manufactured with the polymer gel electrolyte composition according to Comparative Example 1, aluminum corrosion occurred. On the other hand, in the case of the coin cell manufactured with the polymer gel electrolyte composition according to Example 1, aluminum corrosion did not occur.

### Experimental Example 2: Analysis for Optimal Concentration of Cross-linking Agent in Polymer Gel Electrolyte

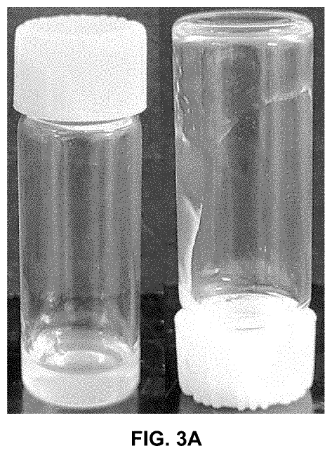

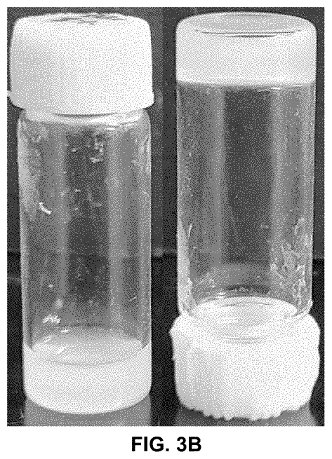

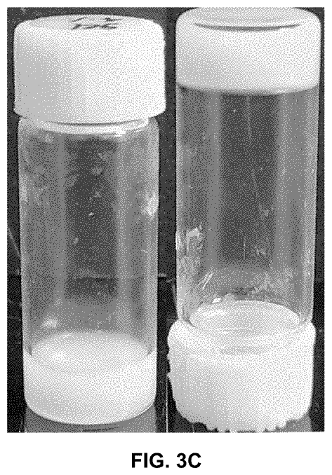

After preparing polymer gel electrolytes according to Comparative Example 2, Comparative Example 3, and Example 2, polymerization results were evaluated as shown in FIGS. 3A to 3C.

FIGS. 3A to 3C show the polymerization results of polymer gel electrolytes prepared according to Comparative Example 2 (FIG. 3A), Comparative Example 3 (FIG. 3B), and Example 2 (FIG. 3C), respectively.

As shown in FIGS. 3A to 3C, when the content of the cross-linking agent was 1% by weight (Comparative Example 2) or 2% by weight (Comparative Example 3), the polymerization reaction proceeded, but the physical properties of the gel were weak. However, when the cross-linking agent was mixed in an amount of 4% by weight (Example 1), it was confirmed that a hard and uniform gel polymer electrolyte was produced.

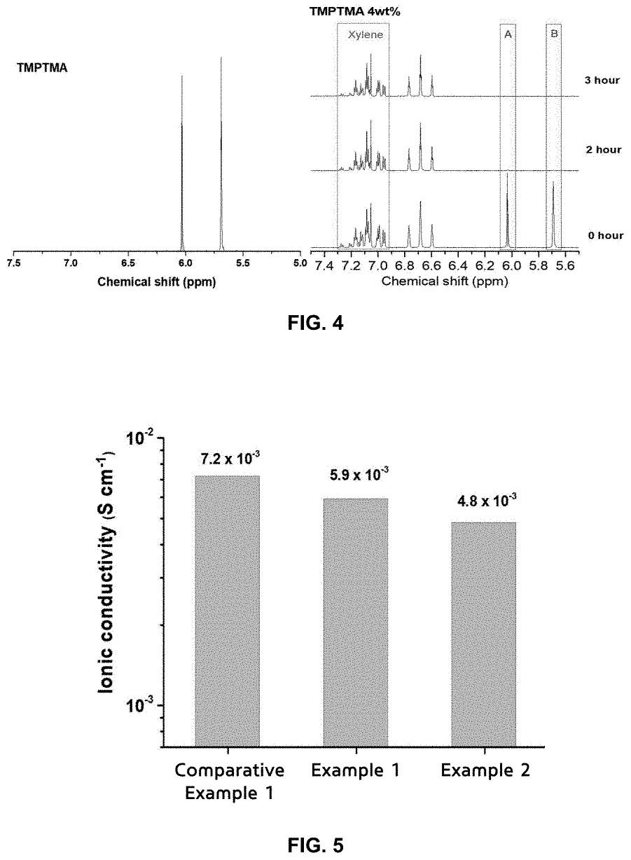

FIG. 4 shows a ¹H NMR measurement graph of the polymer gel electrolyte according to Example 2 and 1% by weight of xylene was added to form as a reference peak, and the conversion ratio was calculated using the ratio of the double bond peak of trimethylolpropane triacrylate with respect to the xylene peak before and after the cross-linking reaction. As a result, it was confirmed that the conversion rate was greater than 99.5% when the reaction was performed at a temperature of 70° C. for 3 hours.

### Experimental Example 3: Evaluation of Ionic Conductivity of Polymer Gel Electrolyte Composition and Polymer Gel Electrolyte

The ionic conductivity for the polymer gel electrolyte compositions according to Example 1 and Comparative Example 1 was analyzed, and the ionic conductivity for the polymer gel electrolyte according to Example 2 was analyzed. The analysis results are shown in FIG. 5.

FIG. 5 shows the ionic conductivity analysis results of the polymer gel electrolyte compositions according to Example 1 and Comparative Example 1 and the ionic conductivity analysis result of the polymer gel electrolyte according to Example 2.

As shown in FIG. 5, the ionic conductivity decreased due to the increase in viscosity as the lithium nitrate as a nitrate was added (Example 1). When the polymer gel electrolyte was prepared by chemical cross-linking of the polymer gel electrolyte composition using the cross-linking agent as in Example 2, the ion conductivity slightly decreased due to the decrease in ion mobility, but the electrolyte had similar ionic conductivity to liquid electrolytes.

### Experimental Example 4: Oxidation Stability Analysis for Polymer Gel Electrolyte Composition and Polymer Gel Electrolyte

The polymer gel electrolyte composition according to Comparative Example 1 and the polymer gel electrolyte according to Example 2 were prepared, and then oxidation stability was evaluated using a leakage current test.

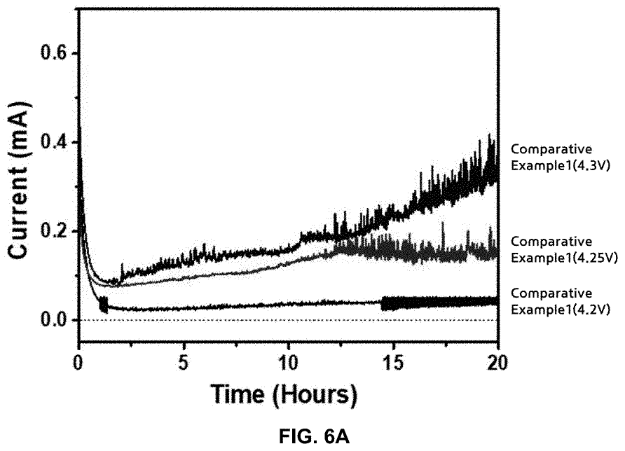

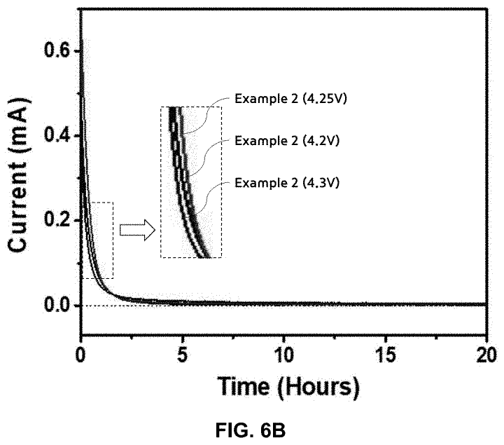

FIGS. 6A and 6B show leakage current test results, at 4.20 V, 4.25 V, and 4.30 V, of the polymer gel electrolyte composition according to Comparative Example 1 (FIG. 6A) and the polymer gel electrolyte according to Example 2 (FIG. 6B).

In general, when the electrolyte is oxidatively decomposed at a high voltage, an oxidation current is generated, and thus a leakage current is observed.

As shown in FIGS. 6A and 6B, in the case of the use of the polymer gel electrolyte composition according to Comparative Example 1 (FIG. 6A), the leakage current greatly increased as the voltage was increased in order of 4.20 V, 4.25 V, and 4.30 V. This means that the oxidative decomposition of the electrolyte occurred. On the other hand, the polymer gel electrolyte according to Example 2 (FIG. 6b) caused no leakage current at all test voltages. This means that the chemically cross-linked gel polymer electrolyte has according to exemplary embodiments had excellent oxidation stability.

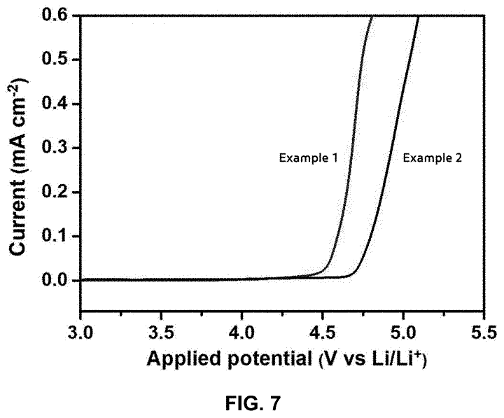

FIG. 7 show linear scanning potential test results of the polymer gel electrolyte composition according to Example 1 and the polymer gel electrolyte according to Example 2.

As shown in FIG. 7, the linear scanning potential test of the polymer gel electrolyte composition according to Example 1 shows that an oxidation current started occurring from about 4.3 V. On the other hand, the polymer gel electrolyte according to Example 2 was electrochemically stable until the test voltage exceeds 4.7 V. Through these results, the oxidation stability of the electrolyte was greatly improved through chemical cross-linking.

### Experimental Example 5: Performance Evaluation of Cell Including Polymer Gel Electrolyte and Protective Layer

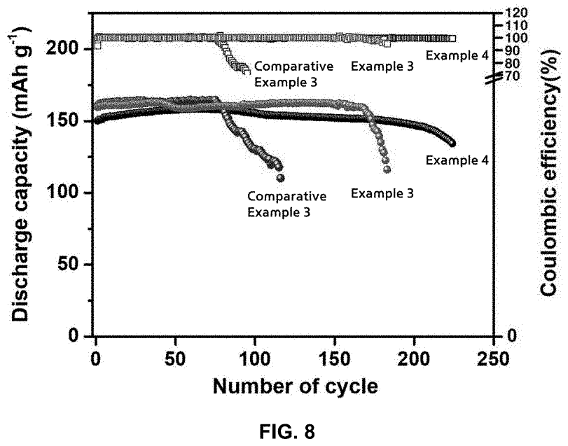

After preparing cells according to Comparative Example 3, Example 3, and Example 4, respectively, charging and discharging were performed twice at a current density of 0.1 C at a voltage in a range of 3.0 to 4.2 V, and then charging and discharging were performed at a current density of 0.33 C. The results are shown in FIG. 8.

FIG. 8 is a graph showing charge and discharge results of the cells according to Comparative Example 3, Example 3, and Example 4.

As shown in FIG. 8, the initial discharge capacity was decreased in the order of the cells according to Comparative Example 3, Example 3, and Example 4, because the ionic conductivity was slightly decreased due to the addition of the polymer gel electrolyte and the protective layer. Accordingly, the lifespan characteristic was reduced in the order of the cells of Example 4, Example 3, and Comparative Example 3.

The test results proved that the polymer gel electrolyte improved the oxidation stability of the ether-based electrolyte and suppressed electrolyte decomposition in the charging and discharging processes, thereby improving lifespan characteristics. In addition, compatibility with lithium metal was improved due to the presence of the protective layer and the physical properties were enhanced due to the organic/inorganic composite, resulting in inhibition of growth of lithium dendrites and improvement in lifespan characteristics.

Since the polymer gel electrolyte according to one embodiment is formed by thermal cross-linking of the polymer gel electrolyte composition including an ether-based organic solvent with excellent compatibility with a lithium metal anode, nitrate capable of forming a stable film on an electrode surface, and an appropriate ratio of a cross-linking agent having two or more acrylate functional groups, the polymer gel electrolyte can smoothly penetrate into the anode to form an ion transport channel and improve oxidation stability through interaction between the polymer and the solvent thereof, thereby improving battery life.

Since the lithium metal battery according to various exemplary embodiments of the present disclosure includes a separator including the polymer gel electrolyte and also includes a protective layer disposed between the anode and the separator and including nanofibers in which an oxide having a double bond on the surface thereof is embedded, a stable interface area may be formed between the lithium metal anode and the electrolyte due to the presence of the polymer gel electrolyte and the protective layer, and a three-dimensional network structure that is effective in suppressing lithium dendrites can be formed because the embedded oxide participates in a chemical reaction.

What is claimed is:

1. A polymer gel electrolyte composition comprising a lithium salt, an ether-based organic solvent, and a nitrate.

2. The polymer gel electrolyte composition according to claim 1, further comprising a cross-linking agent comprising two or more acrylate functional groups.

3. The polymer gel electrolyte composition according to claim 2, wherein the polymer gel electrolyte comprises the cross-linking agent in an amount greater than about 2% by weight and about 4% by weight or less with respect to 100% by weight of the polymer gel electrolyte composition.

4. The polymer gel electrolyte composition according to claim 2, wherein the cross-linking agent comprises one or more selected from the group consisting of trimethylolpropane triacrylate, di-trimethylolpropane tetraacrylate, ethoxylated trimethylolpropane triacrylate, butane diol diacrylate, tripropylene glycol diacrylate, and trimethylolpropane trimethacrylate.

5. The polymer gel electrolyte composition according to claim 1, wherein the lithium salt comprises one or more selected from the group consisting of LiN(SO₂F)₂, LiN(SO₂C₂F₅)₂, LiN(CF₃SO₂)₂, LiPF₆, LiBF₄, LiClO₄, LiCF₃SO₃, LiC₄F₉O₃, LiC₆H₅SO₃, LiSCN, LiB(C₂O₄)₂, LiPO₂F₂, and LiDFOP.

6. The polymer gel electrolyte composition according to claim 1, wherein the ether-based solvent comprises one or more selected from the group consisting of 1,2-dimethoxyethane, 1,3-dioxolane, and tetrahydrofuran.

7. The polymer gel electrolyte composition according to claim 1, wherein the nitrate comprises one or more selected from the group consisting of LiNO₃, NaNO₃, KNO₃, Mg(NO₃)₂, Ca(NO₃)₂, and Ag(NO₃)₂.

8. A polymer gel electrolyte comprising a polymer gel electrolyte composition of claim 1, wherein the polymer gel electrolyte composition is in the state of thermally crosslinked.

9. The electrolyte according to claim 8, wherein the polymer gel electrolyte is obtained by heat treatment of the polymer gel electrolyte composition at a temperature in a range of about 60° C. to 90° C. for about 1 to 5 hours.

10. A lithium metal battery comprising a cathode, an anode, a separator disposed between the cathode and the anode, and a polymer gel electrolyte of claim 8 disposed in the separator.

11. The lithium metal battery according to claim 10, further comprising a protective layer disposed between the anode and the separator.

12. The lithium metal battery according to claim 11, wherein the protective layer comprises nanofibers comprising an oxide having a double bond.

13. The lithium metal battery according to claim 12, wherein the nanofiber comprises an ion conductive polymer comprising one or more selected from the group consisting of polyethylene oxide, polypropylene oxide, polyurethane, polyethylene carbonate, polypropylene carbonate, polyethylene adipate, and polybutylene adipate.

14. The lithium metal battery according to claim 12, wherein the double bond on the surface of the oxide comprises one or more functional groups selected from the group consisting of a vinyl group, an acrylate group, and a methacrylate group.

15. The lithium metal battery according to claim 12, wherein the oxide comprises one or more selected from the group consisting of alumina, silica, titanium oxide, and oxide-based solid electrolytes.

16. The lithium metal battery according to claim 12, wherein the oxide has a diameter of about 20 nm to 400 nm.

17. A vehicle comprising a lithium metal battery of claim 10.
